(19) United States
(12) Patent Application Publication
(10) Pub. No.: US 2025/0251556 A1
(43) Pub. Date: Aug. 7, 2025

(54) ENABLING LONG-RANGE EVANESCENT WAVE COUPLING BETWEEN PHOTONIC WAVEGUIDES

(71) Applicant: Applied Materials, Inc., Santa Clara, CA (US)

(72) Inventors: Zijiao Yang, Frimont, CA (US); Jinxin Fu, Santa Clara, CA (US); Robert Blum, Mountain View, CA (US)

(21) Appl. No.: 19/046,467

(22) Filed: Feb. 5, 2025

Related U.S. Application Data
(60) Provisional application No. 63/550,749, filed on Feb. 7, 2024.

(51) Int. Cl. G02B 6/42

(52) U.S. Cl. CPC G02B 6/4291; G02B 6/4214; G02B 6/4278; G02B 6/428

(57) ABSTRACT

A device includes a plurality of conductive layers, a plurality of inner cores disposed in a region between a first set of conductive layers of the plurality of conductive layers and a second set of conductive layers of the plurality of conductive layers, each inner core of the plurality of inner cores corresponding to a respective waveguide of a plurality of waveguides, wherein the plurality of inner cores is arranged in a cascaded waveguide structure, and dielectric material simultaneously forming an interlevel dielectric for the plurality of conductive layers and at least a portion of a cladding layer for each waveguide of the plurality of waveguides.

### CROSS-REFERENCE TO RELATED APPLICATION(S)

The present application claims priority to U.S. Provisional Patent Application No. 63/550,749, filed on Feb. 7, 2024 and entitled “ENABLING LONG-RANGE EVANESCENT WAVE COUPLING BETWEEN PHOTONIC WAVEGUIDES”, the entire contents of which are hereby incorporated by reference herein.

### TECHNICAL FIELD

Embodiments of the present disclosure relate to optical systems, and more particularly to enabling long-range evanescent wave coupling between photonic waveguides (“waveguides”).

### BACKGROUND

In an optical system, an optical signal can travel through a waveguide (e.g., optical fiber) that is formed from an inner core made of a first material having a first index of refraction and an outer cladding made of a second material having a second index of refraction less than the first index of refraction. For example, the first material and the second material can each be formed from a different type of glass. Thus, when an optical signal traveling in a waveguide is incident on the boundary between the inner core and the outer cladding at an angle exceeding the critical angle, the optical signal can exhibit total internal reflection. At the boundary, an evanescent wave can be generated from the optical signal. Generally, an evanescent wave is an oscillating wave (e.g., electromagnetic wave or acoustic wave) generated at a boundary between two media and exists only within a very short distance from the boundary. Evanescent waves can exit the waveguide, and their amplitude can decay exponentially as a function of distance from the boundary. Thus, evanescent waves are generally observable in the near field of the optical signal in close proximity to the boundary.

Evanescent wave coupling generally refers to a (quantum) tunneling phenomenon in which an evanescent wave exiting a first medium excites a wave in an adjacent medium that is sufficiently close to the first medium. For example, in an optical communication system, evanescent wave coupling can occur when an evanescent wave generated within a waveguide excites an electromagnetic wave in an adjacent waveguide. Evanescent wave coupling can be accomplished when two waveguides are positioned close together such that the evanescent field generated by one of the waveguides reaches the other waveguide before any substantial decay of the evanescent wave is experienced.

### SUMMARY

In some embodiments, a device includes a plurality of conductive layers, a plurality of inner cores disposed in a region between a first set of conductive layers of the plurality of conductive layers and a second set of conductive layers of the plurality of conductive layers, each inner core of the plurality of inner cores corresponding to a respective waveguide of a plurality of waveguides, wherein the plurality of inner cores is arranged in a cascaded waveguide structure, and dielectric material simultaneously forming an interlevel dielectric for the plurality of conductive layers and at least a portion of a cladding layer for each waveguide of the plurality of waveguides.

In some embodiments, a device includes a plurality of conductive layers, a plurality of inner cores disposed in a region between a first set of conductive layers of the plurality of conductive layers and a second set of conductive layers of the plurality of conductive layers, each inner core of the plurality of inner cores corresponding to a respective waveguide of a plurality of waveguides, wherein the plurality of inner cores is arranged in a cascaded waveguide structure, at least a first dielectric material simultaneously forming an interlevel dielectric for the plurality of conductive layers and a first portion of a cladding layer for each waveguide of the plurality of waveguides, the first dielectric material having a first index of refraction, and at least one cladding structure disposed between at least one pair of inner cores to form a second portion of the cladding layer for at least one pair of waveguides corresponding to the at least one pair of inner cores, the at least one cladding structure comprising a second dielectric material having a second index of refraction greater than the first index of refraction.

In some embodiments, a system includes a printed circuit board, at least one interconnect disposed on the printed circuit board, and a set of photonic integrated circuits disposed on the at least one interconnect. The least one interconnect includes a plurality of conductive layers, a plurality of inner cores disposed in a region between a first set of conductive layers of the plurality of conductive layers and a second set of conductive layers of the plurality of conductive layers, each inner core of the plurality of inner cores corresponding to a respective waveguide of a plurality of waveguides, wherein the plurality of inner cores is arranged in a cascaded waveguide structure, and dielectric material simultaneously forming an interlevel dielectric for the plurality of conductive layers and at least a portion of a cladding layer for each waveguide of the plurality of waveguides.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a diagram of a perspective view of at least a portion of a co-packaged substrate having one or more electrical and photonic devices formed thereon, in accordance some embodiments.

FIGS. 2A-2B are diagrams of top views of photonic integrated interconnect units, according to some embodiments.

FIGS. 3-5 are diagrams of cross-sectional views of portions of a photonic integrated interconnect unit, according to some embodiments.

FIG. 6 is a diagram of a cross-sectional view of a portion of a pluggable connector, according to some embodiments.

FIGS. 7A-7B are diagrams of views of a system including a device that can enable long-range evanescent wave coupling between photonic waveguides, according to some embodiments.

FIGS. 8A-8B are diagrams of views of a device that can enable long-range evanescent wave coupling between photonic waveguides, according to some embodiments.

FIGS. 9A-9B are diagrams of views of a device that can enable long-range evanescent wave coupling between photonic waveguides, according to some embodiments.

### DETAILED DESCRIPTION

Embodiments of the present disclosure relate to enabling long-range evanescent wave coupling between photonic waveguides (“waveguides”). A co-packaged device (e.g., multi-chip module) can include a package substrate having multiple integrated circuit devices assembled closely together. More specifically, optical components can be integrated on substrates (e.g., silicon (Si) substrate) for fabricating large-scale photonics integrated circuits that co-exist with micro-electronic chips. With the use of an optical transceiver, received optical signal can be converted to an electrical signal capable of being processed by an integrated circuit, or the processed electrical signal can be converted to an optical signal to be transmitted via an optical fiber.

A co-packaged device can include an interconnect device (“interconnect”) disposed between a first component and a second component. For example, an interconnect can be a placed between a package substrate and a ball grid array. In some embodiments, an interconnect includes an interposer. An interposer is an electrical interface that routes connections between sockets or connections between the first component and the second component. An interposer can be used to connect components that may not naturally connect to one another.

Some interconnects (e.g., interposers) can include multiple conductive layers (e.g., metal layers), where pairs of conductive layers are connected by at least one conductive via (“via”). For example, a first conductive layer of a first metallization level and a second conductive layer of a second metallization level can be connected by at least one via.

Some interconnects (e.g., interposers) can further include multiple waveguides integrated near the conductive layers. The waveguides of an interconnect can use evanescent wave coupling to transmit an optical signal received from an initial waveguide of the interconnect to a final waveguide of the interconnect. For example, the initial waveguide can be integrated near a bottom conductive layer of the interconnect, and the final waveguide can be integrated near a top conductive layer of the interconnect.

Typically, the distance between a pair of conductive layers including a first conductive layer and a second conductive layer connected by at least one via can be greater than or equal to about 10 micrometers (μm). However, the waveguides of the interconnect generally should be placed sufficiently far away from conductive material (e.g., metal) for efficient interconnect operation. Accordingly, due to how quickly evanescent waves decay as a function of distance, the distance between each pair of waveguides may be too large to effectively use evanescent wave coupling to transmit optical signals between waveguides through the interconnect.

Aspects and implementations described herein can address these and other drawbacks by enabling long-range evanescent wave coupling between waveguides. A device described herein can include conductive material including multiple conductive layers and multiple vias, where pairs of conductive layers are connected by at least one via. In some embodiments, the distance between a pair of conductive layers (e.g., a first conductive layer and a second conductive layer) connected by at least one via can be greater than or equal to about 10 μm. In some embodiments, the device is an interconnect of a co-packaged optical device or system. For example, the device can be an interposer.

The device can further include multiple waveguides. Each waveguide can include an inner core formed from any suitable inner core material. In some embodiments, the inner core material is a dielectric material. For example, the inner core material can include silicon nitride.

To enable the long-range evanescent wave coupling, the device can include a waveguide structure designed to reduce evanescent wave coupling loss and improve evanescent wave coupling efficiency. In some embodiments, the waveguide structure is a cascaded waveguide structure. The cascaded waveguide structure can be used to gradually couple waves from one waveguide to the next waveguide to reduce coupling power loss (e.g., less than about 0.1 decibel (dB) loss in power). The cascaded waveguide structure can include a staircase pattern. More specifically, multiple waveguides can have inner cores arranged in a staircase pattern from an initial inner core to a final inner core in a manner to enable evanescent wave coupling between respective pairs of waveguides of the cascaded waveguide structure. For example, in the staircase pattern, the initial (first) inner core has a first end to receive an optical signal, and a second end disposed underneath a second inner core in a location between a first end and a second end of the second inner core. The first end of the second inner core is located above the first inner core in a location between the first end and the second end of the first inner core. The final (last) inner core can have a first end located above a penultimate inner core in a location between a first end and a second end of the penultimate inner core, and a second end disposed near an output waveguide. The initial waveguide and the final waveguide can each be located at a distance away from an initial conductive layer and a final conductive layer. In some embodiments, the distance is about 3 μm., which can be located sufficiently close to another waveguide to enable evanescent wave coupling.

The conductive material and the inner cores can be encapsulated by at least one material that is suitable to simultaneously function as an insulator between the conductive layers, and as cladding layers for the inner cores for each waveguide suitable for optical coupling with low absorption and/or propagation loss. The at least one material can include any suitable material(s) in accordance with embodiments described herein. In some embodiments, the at least one material includes at least one dielectric material. For example, the at least one dielectric material can include silicon dioxide. Accordingly, the at least one material can form an interlevel dielectric (ILD) layer with respect to the conductive material.

In some embodiments, the waveguide structure includes supplemental cladding structures disposed between respective inner cores. More specifically, the conductive layers can be encapsulated by the at least one material to provide insulation between the conductive layers (e.g., similar to the at least one material described above). Instead of the at least one material forming the cladding layers on the inner cores of the waveguides, the cladding layers may be formed from separate supplemental cladding structures. Each supplemental cladding structure can be formed from a cladding material (e.g., a dielectric material) having a higher index of refraction than the dielectric material used to form the ILD layer (e.g., a material having a higher index of refraction than silicon dioxide). A supplemental cladding structure can reduce coupling loss because of its higher index of refraction. In some embodiments, a supplemental cladding structure has a tapered geometry to reduce reflection loss at the respective boundaries between the supplemental cladding structure and the inner cores. For example, the supplemental cladding structure can have a parallelogram shape (e.g., rhombus shape) as viewed from a side of the device.

Embodiments described herein can provide for numerous other technical advantages. For example, embodiments described herein can reduce evanescent wave decay within devices (e.g., interconnects), which can improve the ability of waveguides of these devices to transmit optical signals.

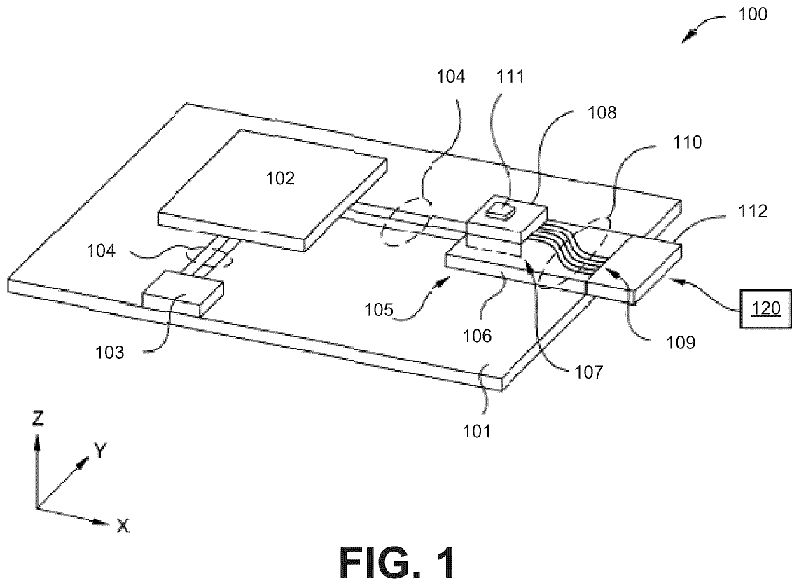

FIG. 1 is a diagram of a perspective view of a system including a co-packaged device 100, in accordance some embodiments. The co-packaged device 100 can include an electrical or opto-electrical chip (“chip”) 102 connected by a waveguides or electrical trace interconnect 104 to a photonic integrated interconnect unit 103 where all are formed on or disposed on a package substrate 101. In some embodiments, the chip 102 includes any high-density chip having a high input/output (I/O) pin count. In one example, the high-density chip has between 100 and 2000 I/O pins or up to and greater than 2000 I/O pin counts. For example, the chip 102 can be a data center SWITCH chips, an artificial intelligence (AI) chip, etc.

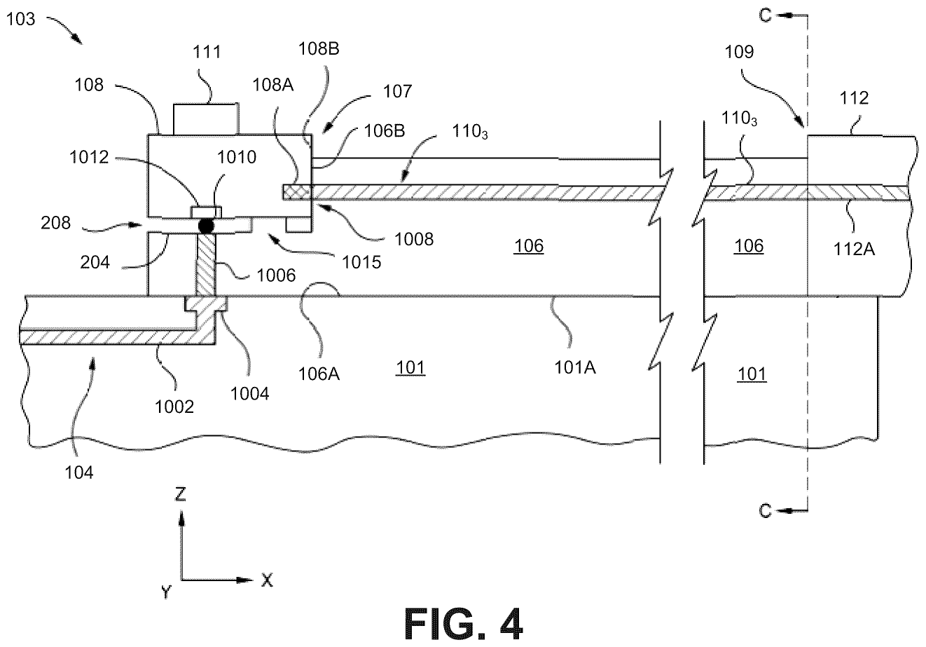

The photonic integrated interconnect unit 103 includes a fiber connector region configured to be coupled to a fiber connector 112 for removably connecting a fiber cable 120 to the photonic integrated interconnect unit 103. In some embodiments, the fiber cable 120 is plugged into the fiber connector 112 to operably connect the fiber cable 120 to the co-packaged device 100. In an embodiment, the photonic integrated interconnect unit 103 is configured for connecting the fiber cable 120 including, but not limited to, single-mode fiber optic cables having 9 μm fiber core diameters. The fiber connector 112 may further include optical fibers 112A (FIG. 4) to operably connect fiber cables 120 having between 1 to 74 fiber cores, 74 to 148 fiber cores, and up to and greater than 148 fiber cores to the photonic integrated interconnect unit 103.

In some embodiments, the photonic integrated interconnect unit 103 is configured to transmit signals between the chip 102 and the fiber cable 120 connected to the photonic integrated interconnect unit 103. The photonic integrated interconnect unit 103 includes a photonic glass layer (PGL) substrate 106, optical structure 110₁ through optical structure 110_{N} (including the optical structure 110_{N-1}) formed integral with or on the PGL substrate 106, an optical transceiver integrated circuit (chip) 108 mounted on the PGL substrate 106 and coupled to the optical structures 1101-110_{N} at a first interface 107, and the fiber connector 112 connected to both the PGL substrate 106 and the optical structures 110₁-110_{N} at a second interface 109.

The chip 108 operates to convert electrical signals to optical signals, and vice versa. In some embodiments, the chip 108 is a silicon photonic (SiPho) chip. The optical structures 110₁-110_{N} operate to transmit optical signals between the chip 108 and the fiber connector 112, and the photonic waveguide or electrical trace interconnect 104 operate to transmit electrical or optical signals between the photonic integrated interconnect unit 103 (e.g., the chip 108) and the chip 102. The photonic waveguide or electrical trace interconnect 104 can include metal traces that are formed within the package substrate 101, which in some embodiments can include metal traces formed in a printed circuit board (PCB) substrate or metal traces formed within multiple redistribution layers (e.g., dielectric containing layers) formed over a solid core substrate (e.g., silicon or glass core substrate).

A photonic engine 105 may optionally further include one or more electronic phy chips 111 that are coupled to the chip 108. The electronic phy chip 111 is generally used to assist with operations performed by an optical chip. In some embodiments, the electronic phy chip 111 is operably connected to the chip 108 to assist the chip 108 with various electrical functions. As shown, the electronic phy chips 111 may be mounted on top of the chip 108 and thereby directly connected to the chip 108. Alternatively, the electronic phy chip 111 may be embedded in the PGL substrate 106 and connected to the chip 108 through the PGL substrate 106. Further, the electronic phy chip 111 can be mounted on or embedded in the package substrate 101 and connected to the chip 108 through electrical trace interconnect 104.

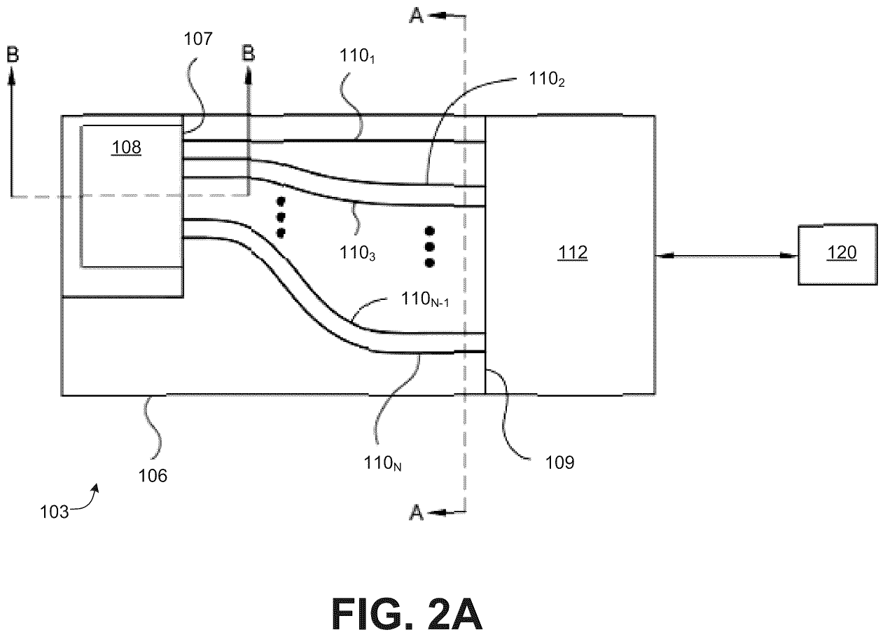

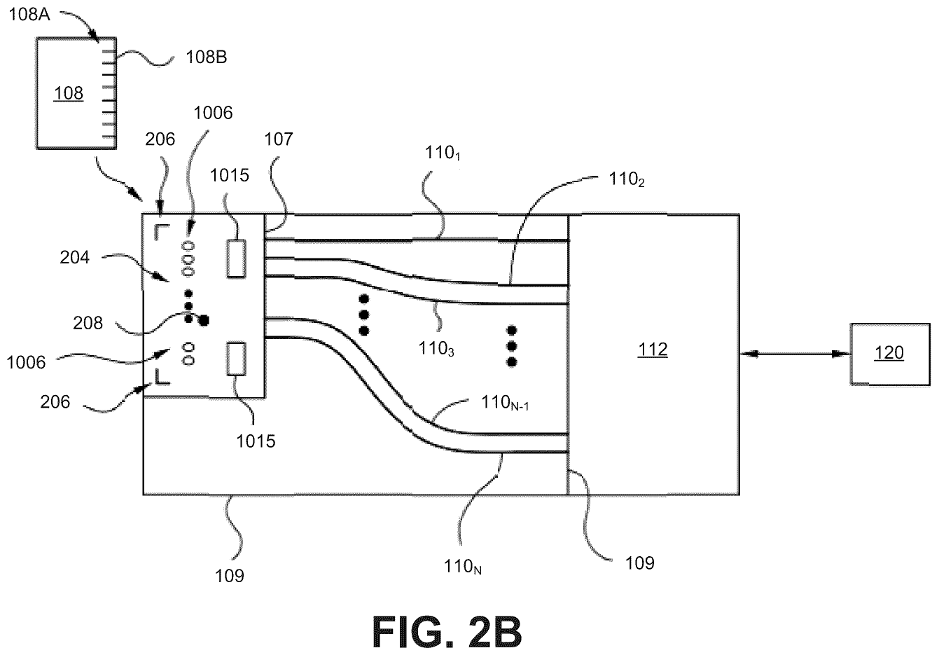

FIGS. 2A-2B are diagrams of top views of the photonic engine 105, according to some embodiments. As shown in FIG. 2A, the photonic engine 105 includes the chip 108 mounted near one end of the PGL substrate 106, the fiber connector 112 connected at an opposite end of the PGL substrate 106 from the chip 108, and the optical structures 110₁-110_{N} extending between the chip 108 and the fiber connector 112. In some embodiments, each of the optical structures 110₁-110_{N} include a light transmitting region for transmitting light in either direction between the first interface 107 and the second interface 109. The light being transmitted through the optical structures can be either received from one or more waveguides 108A (FIG. 2B) of the chip 108 or received from one or more optical fibers within the fiber connector 112 that a light signal source is in communication with during use. The chip 108 is typically configured to receive light (e.g., detect) transmitted through the optical structures 110₁-110_{N} and also emit light (e.g., transmit) into the optical structures 110₁-110_{N} in an effort to communicate with external devices connected through the fiber connector 112. The chip 108 can be configured to transmit light into the optical structures 110₁-110_{N} by at least the use of light emitters integrated into chip 108, or by use of light emitters that are external to PGL substrate 106. In the case where the light emitters are external to PGL substrate 106 the light is delivered to chip 108 via the optical structures 110₁-110_{N} and then modulated by the chip 108 to create a transmit signal that is provided to the optical structures 110₁-110_{N}. In some embodiments, which can be combined with other embodiments described herein, the optical structures 110₁-110_{N} are formed on (e.g. directly or indirectly) or are integral with the PGL substrate 106.

In some embodiments, which can be combined with other embodiments described herein, the light transmitting region within each of the optical structures 110₁-110_{N} may have the same cross-sectional dimensions, such as height and width. In another embodiment, which can be combined with other embodiments described herein, the light transmitting region within at least one of the optical structures 110₁-110_{N} may have at least one different cross-sectional dimensions, such as one of height and width, from the dimensions of the other optical structures 110 within the PGL substrate 106. In one embodiment, which can be combined with other embodiments described herein, the light transmitting region within each of the optical structures 110₁-110_{N} may have the same refractive index. In another embodiment, which can be combined with other embodiments described herein, the light transmitting region within at least one of the optical structures 110₁-110_{N} may have a different refractive index or multiple different refractive indexes or a gradual gradation of refractive indexes or other index varying structures when compared with the rest of the optical structures 110₁-110_{N} within the PGL substrate 106.

In some embodiments, the number of optical structures 110₁-110_{N} formed in the PGL substrate 106 is dependent on the number of waveguides 108A in the chip 108 needing to be connected, which may also correspond with the number of fiber connections to be connected to the chip 102. In some embodiments, the chip 102 may comprise seventy-two (72) fiber connections such that seventy-two (72) corresponding electrical trace interconnects 104 extend from the chip 102 and connect to seventy-two (72) corresponding fibers and waveguides 108A in the chip 108 of the photonic engine 105. To appropriately connect the chip 108 to the fiber connector 112 via the optical structures 110₁-110_{N} in the PGL substrate 106, seventy-two (72) corresponding optical structures 110₁-110_{N} are formed on or integral with the PGL substrate 106. In this example, as shown in FIGS. 2A-2B, N equals 72, and thus the optical structures 110 are spaced apart in the X-Y plane from one edge of the PGL substrate 106 to the other edge of the PGL substrate 106. In this example, optical structure 110₁ is positioned near the top-most edge and optical structure 110₇₂ would be positioned closest to the bottom most edge of FIG. 2A. As discussed further below, the optical structures 110₁-110_{N} are spaced apart and separated by a material that has different optical properties, such as index of refraction (n), than the light transmitting portions of the optical structures 110₁-110_{N}.

The optical structures 110₁-110_{N} are generally sized and configured to appropriately connect to the waveguides 108A within the chip 108. In an embodiment, the waveguides 108A (FIG. 2B) at the output of the chip 108, or portion that is to communicate with the optical structures, have a core with a height dimension that is about 1 μm in cross-sectional size. In one configuration, the output of the chip 108 has a square or rectangular shaped cross-section that has at least one dimension that is equal to about 1 μm in length. For example, a square cross-section of a waveguide 108A may have a core that is 1 μm height and width. Light transmitted to and from the chip 108 would thus be transferred through the 1 μm waveguides 108A.

In contrast, light transmitted to and from the fiber cable 120 through the fiber connector 112 can have a different form factor, such as having a core cross sectional dimension of about 9 μm in size. For example, the fiber connector 112 may have a square, rectangular or circular cross-section with a core having a height dimension that is about 9 μm in size. As such, in some embodiments, each of the optical structures 110₁-110_{N} is formed such that light propagating through the optical structures 110₁-110_{N} between the chip 108 and the fiber cable 120 is expanded or compressed accordingly depending on the direction of propagation of the optical signal. In one example, the optical structures 110₁-110_{N} extending from the second interface 109 adjacent to the 9 μm fibers in the fiber connector 112 have transmission regions with cross-sectional areas that vary at different portions of the respective structures to facilitate coupling to the 1 μm waveguides 108A in the chip 108. In one embodiment, the optical structures 110₁-110_{N} are tapered along at least a portion of their length from a 9 μm dimensional core size until they are near 1 μm dimensional core size near the first interface 107, where it is assumed that the varying dimensional core size relates to a dimension of a side of a square or rectangular cross-sectional shaped optical structure. In some embodiments, the tapered optical structures 110₁-110_{N} have a cross-sectional area ratio, which if measured at one end versus measured at the opposing end of the optical structure 110 is greater that 1:1 and less than about 1:100, or less than 1:81. In some embodiments, the optical structures 110₁-110_{N} extending from the second interface 109 adjacent to the fiber connector 112 have a varying refractive index along at least a portion of their length from the second interface 109 to the first interface 107 to facilitate coupling between the optical elements within the chip 108 and the fiber connector 112 that have different cross-sectional dimensions.

In another aspect, the photonic engine 105 is configured such that the transmission loss of the optical signal between the first interface 107 and the second interface 109 is approximately or less than 3 dB, inclusive of loss due to the transmission of the optical signal through the optical structures 110₁-110_{N} themselves. In some embodiments, the transmission loss may largely be dependent on the coupling at the first interface 107 between the chip 108 and the optical structures 110₁-110_{N}. As shown in FIG. 2B, in an embodiment, the chip 108 is to be mounted on a coupling surface 208 at a chip mounting region 204 of the PGL substrate 106. When mounted on chip mounting region 204, the waveguides 108A disposed on the side surface 108B of the chip 108 are aligned with the optical structures 110₁-110_{N} found at the first interface 107.

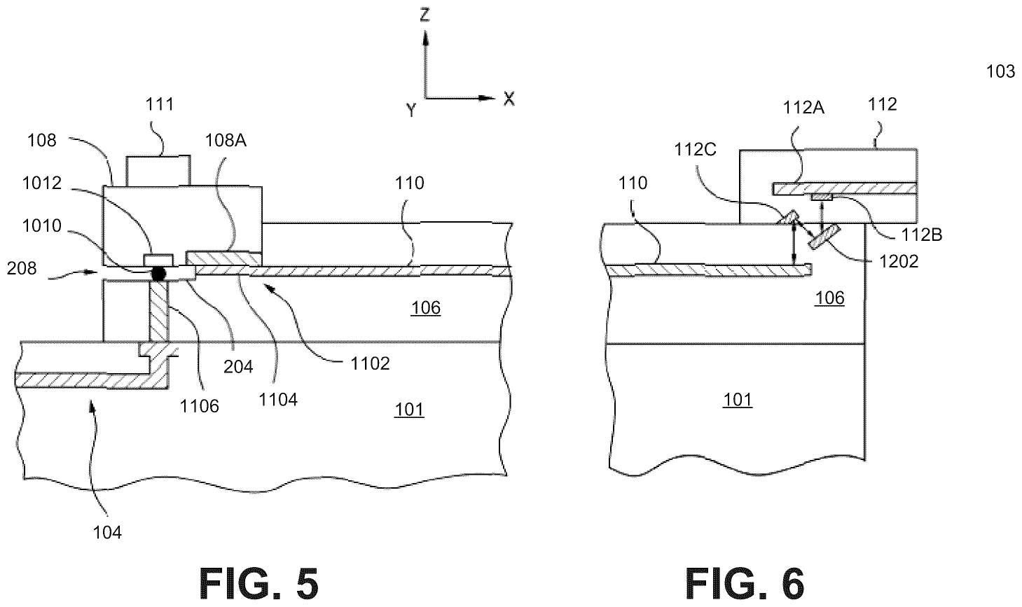

In some embodiments, the PGL substrate 106 further includes one or more fiducial marks 206 to assist in the alignment and mounting of the chip 108 on the chip mounting region 204. The one or more fiducial marks 206 operate to guide and help align the position of the chip 108 along the X-Y plane of the PGL substrate 106 to ensure mounting of the chip 108 occurs with proper alignment to one or more electrical contacts (e.g., vias 1006) and optical structure portions of the PGL substrate 106. As such, in an embodiment, the tolerance for error in the coupling or hybrid bonding the chip 108 and the optical structures 110₁-110_{N} together at the first interface 107, which will be discussed further below, may be in a range from 0.1 to 2 μms to ensure the connections are optimized for the lowest signal loss. In one embodiment, the misalignment of the centers of the waveguides 108A and the optical structures 110₁-110_{N} is maintained such that the lateral misalignment in the Y-direction (i.e., top to bottom direction in FIG. 2B) is less than 1 to 2 μms. In some embodiments, the misalignment of the centers of the waveguides 108A and the optical structures 110₁-110_{N} is also maintained such that the vertical misalignment in the Z-direction (FIGS. 4-5) is less than 1 to 2 μms. In one embodiment, the variability in the vertical misalignment can be dependent on the variability of the compression of solder balls 1010 or other electrical contact that is used to electrically couple the chip 108 to vias 1006 (shown in FIGS. 4-5) formed in a portion of the PGL substrate 106.

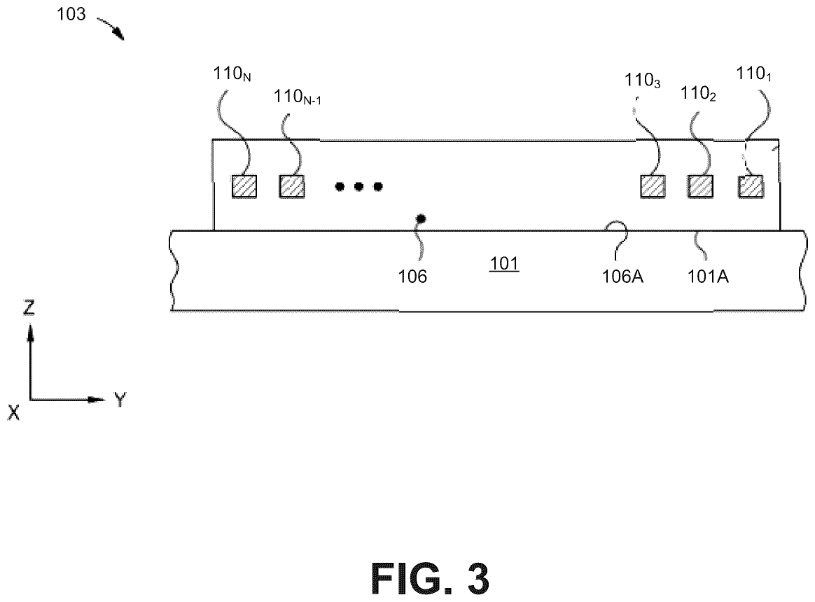

FIG. 3 is a diagram of a schematic, cross-sectional end view of a portion of the photonic engine 105 mounted on the package substrate 101 formed by use of the sectioning line C-C in FIG 4., according to some embodiments. As shown in FIG. 3, the photonic engine 105 includes a bottom surface 106A of the PGL substrate 106 disposed on a top surface 101A of the package substrate 101 (e.g., an upper surface or upper surfaces), with the optical structures 110₁-110_{N} extending through the PGL substrate 106. As shown, the optical structures 110₁-110_{N} extending through the PGL substrate 106 are each aligned in the X-Z plane of the PGL substrate 106. While FIG. 3 shows the optical structures 110₁-110_{N} formed in a single row in plane across the PGL substrate 106, other arrangements of the optical structures 110₁-110_{N} may be formed in the PGL substrate 106. For example, more than a single row of optical structures may be formed and stacked vertically. The arrangements of the optical structures 110₁-110_{N} is not intended to limit the scope of the disclosure provided herein.

FIG. 4 is a schematic, transverse cross-sectional lateral view of a portion of the photonic engine 105 mounted on the package substrate 101 that is formed by use of the sectioning line B-B in FIG. 2A, according to some embodiments. As shown in FIG. 4, the package substrate 101 includes circuit traces 1002 extending from interconnect pads 1004 formed integral in the top surface 101A of package substrate 101. In some embodiments, the circuit traces 1002 form the electrical trace interconnects 104 that electrically connect the photonic engine 105 in contact with the interconnect pads 1004 to the chip 102. Alternatively, the circuit traces 1002 may electrically connect the photonic engine 105 in contact with the interconnect pads 1004 to other integrated circuits disposed on the package substrate 101.

In some embodiments, the vias 1006 extend through a portion of the PGL substrate 106 between the coupling surface 208 and the bottom surface 106A of the PGL substrate 106. When the photonic engine 105 is mounted to the package substrate 101, the vias 1006 can be aligned with and placed in electrical contact with the corresponding interconnect pads 1004 that are exposed on the top surface 101A of package substrate 101 and are in electrical connection with the photonic integrated interconnect unit 103 through the circuit traces 1002 formed in the package substrate 101. In some embodiments, the vias 1006 alternatively connect the photonic engine 105 to one or more other integrated circuits (chips) embedded in the package substrate 101 or on the package substrate 101.

As shown in FIG. 4, the chip 108 can be actively or passively mounted on the coupling surface 208 of the PGL substrate 106 with the side surface 108B of the chip 108 are “butt-coupled” to an end surface 106B of the PGL substrate 106 at the first interface 107. When the chip 108 is butt-coupled to the end surface 106B of the PGL substrate 106, the end of the waveguide 108A in the chip 108 is also butt-coupled to a corresponding end of the optical structure 110, such as optical structure 110₃, formed in the PGL substrate 106 at a fourth coupling interface 1008. The coupling of the waveguides 108A to the optical structures 110 at the fourth coupling interface 1008 can impact the loss of optical signals between the chip 108 and the PGL substrate 106. As such, to minimize coupling loss, the aforementioned one or more fiducial marks 206 (FIG. 2B) are used during mounting of the chip 108 to assist in alignment and the precise placement of the chip 108 to optimize the butt-coupling of the waveguides 108A and the optical structures 110₁-110_{N} at the fourth coupling interface 1008 and minimize coupling loss.

To connect the chip 108 to the PGL substrate 106, chip 108 further includes solder connects 1012 that are in contact with the solder balls 1010, wherein the solder balls 1010 are positioned between the solder connects 1012 and an end of each of the vias 1006 on the coupling surface 208. The solder balls 1010 electrically connect the chip 108 to the vias 1006 formed in the PGL substrate 106. In some embodiments, the solder balls or other interconnect bumps, pillars or interconnect materials, including planar hybrid bonding techniques, 1010 are used to connect the solder connects 1012 to the vias 1006 extending through the PGL substrate 106 to the package substrate 101. In the embodiment shown, the solder balls 1010 and the vias 1006 connect the solder connects 1012 to the interconnect pads 1004 in the package substrate 101, thereby electrically connecting the chip 108 to the circuit traces 1002 in the package substrate 101 connected to the interconnect pads 1004.

In some embodiments, the coupling surface 208 of the PGL substrate 106 further includes a plurality of recesses (not shown) for cradling each of the solder balls 1010 used to connect the solder connects 1012 in the chip 108 and the vias 1006 in the PGL substrate 106. The recesses may be formed to allow for expansion of the solder balls 1010 when flattened such that the contacting surface of the solder balls 1010 may be substantially flush with the coupling surface 208. The flattening of the solder balls 1010 on the coupling surface 208 when contacting the solder connects 1012 in the chip 108 helps ensure uniformity in the mounting of the chip 108 on the PGL substrate 106 as well as increases contact reliability of the solder balls 1010.

FIG. 4 also includes a cross-sectional view of a portion of the fiber connector 112 that is coupled to a portion of the PGL substrate 106 at the second interface 109, according to some embodiments. The fiber connector 112 can be removably connected to a portion of the photonic engine 105 to allow the transmission to and receipt of optical signals from the optical structures 110 by use of a “butt-coupled” connection configuration.

FIG. 5 is a schematic, cross-sectional lateral view of a portion of the photonic engine 105 mounted on the package substrate 101, according to some embodiments. As shown, the chip 108 may be passively mounted on the PGL substrate 106 in a second chip mounting region 1106 of the PGL substrate 106. The second chip mounting region 1106 of the PGL substrate 106 further includes a coupling portion 1102 of each of the optical structures 110₁-110_{N} extending along a coupling surface 1104 of the PGL substrate 106. When the chip 108 is mounted on the second chip mounting region 1106, a portion of the waveguides 108A in the chip 108 are evanescently coupled with a surface of the corresponding coupling portions 1102 of each of the optical structures 110₁-110_{N} in the PGL substrate 106. The evanescent wave coupling of the waveguides 108A to the optical structures 110 allow for optical signals to be transferred between the coupled waveguides.

In some embodiments, the evanescently coupling of the waveguides may be formed as a directional coupler wherein the evanescent modes of one waveguide overlap with the modes of a second waveguide. When the evanescent modes of the waveguides overlap, evanescent fields generated by the respective waveguides also overlap such that the evanescent field generated by one waveguide may excite a wave in the other waveguide. As such, in one aspect, the coupling strength between the waveguides 108A and the optical structures 110 may therefore be sensitive to the distance between the waveguides 108A and optical structures 110, and/or the length of the coupling portion 1102. The coupling portion 1102 and respective contacting portion of the waveguides 108A may therefore be sized and formed to optimize the coupling and minimize coupling loss.

The mounting of the chip 108 on the PGL substrate 106 in the second chip mounting region 1106 of the PGL substrate 106 further includes connecting the solder connects 1012 in the chip 108 to the vias 1006 in the PGL substrate 106 using the solder balls 1010. The solder balls 1010 may be positioned on the coupling surface 208 adjacent to the coupling portions 1102 of the optical structures 110₁-110_{N} and aligned between each respective solder connects 1012 and via 1006. The solder balls 1010 may be sized such that when the solder balls 1010 is flattened due to the contact of the chip 108 being mounted on the PGL substrate 106, the solder balls 1010 is flattened to a height substantially the same as the height of the coupling portions 1102 of the optical structures 110₁-110_{N}. In the embodiment shown, the solder balls 1010 in contact with the vias 1006 and the interconnect pads 1004 electrically connect the chip 108 to the circuit traces 1002 in the package substrate 101. Further, one or more stand-off structures 1015 can be used to position, support and/or help align the chip 108 within the chip mounting region 204. In one example, the stand-off structures 1015 (FIG. 4) are formed to help set the vertical alignment of the waveguides 108A with the optical structures 110. In some embodiments, the PGL substrate 106 includes one or more stand-off structures 1015 that are configured to support the chip 108 in a direction (e.g., Z-direction) that is substantially perpendicular to a plane that is parallel to the plane in which the optical structures 110₁-110_{N} extend (e.g., X-Y-plane).

FIG. 6 is a schematic, cross-sectional lateral view of the fiber connector 112 portion of the photonic engine 105, according to some embodiments. In general, the fiber connector 112 is used to removably connect the external fiber cable 120 to the photonic engine 105. The optical fibers 112A of the fiber connector 112 transmit light signals to and from the fiber cable 120 plugged into the fiber connector 112. The fiber connector 112 is configured to allow for the attachment of the external fiber cable 120 to the optical input/output of the photonic engine 105 without requiring active alignment of the fiber cable 120 to the photonic engine 105 on a per fiber core basis. As such, the fiber connector 112 may be formed and configured to be interoperable with a variety of different fiber cable 120 assemblies and standards. Light transmitted along the optical fibers 112A is directed to the optical structures 1101-110N on the PGL substrate 106 by a lens assembly for subsequent transmittance to and through the photonic engine 105. The lens assembly includes a first lens 112B and a third lens 112C formed on the fiber connector 112, and a second lens 1202 formed on the PGL substrate 106. As shown, light from the fiber cable 120 is transmitted along the optical fiber 112A towards the first lens 112B formed near the end of the optical fiber 112A. The first lens 112B directs light transmitted along the optical fiber 112A towards the second lens 1202 on the PGL substrate 106. The second lens 1202 on the PGL substrate 106 then reflects and re-direct the light back towards the third lens 112C on the fiber connector 112. The third lens 112C finally reflects and re-directs the light to the optical structures 110 on the PGL substrate 106 for subsequent transmittance through the photonic engine 105.

FIGS. 1-6 have described optical photonic devices having multiple optical structures formed on a substrate (e.g., glass substrate). The optical photonic device can include a photonic chip mounted on the photonic substrate and connected to multiple optical structures. The optical structures optically connect the photonic chip to a fiber connector configured to connect with an external fiber and operate to propagate light signals between the fiber connector and the photonic chip.

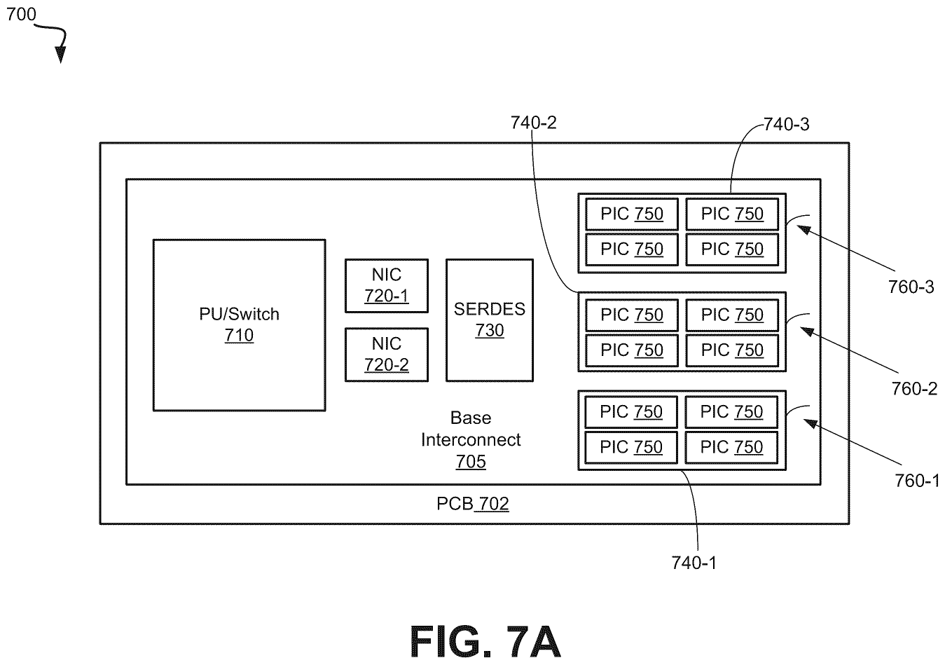

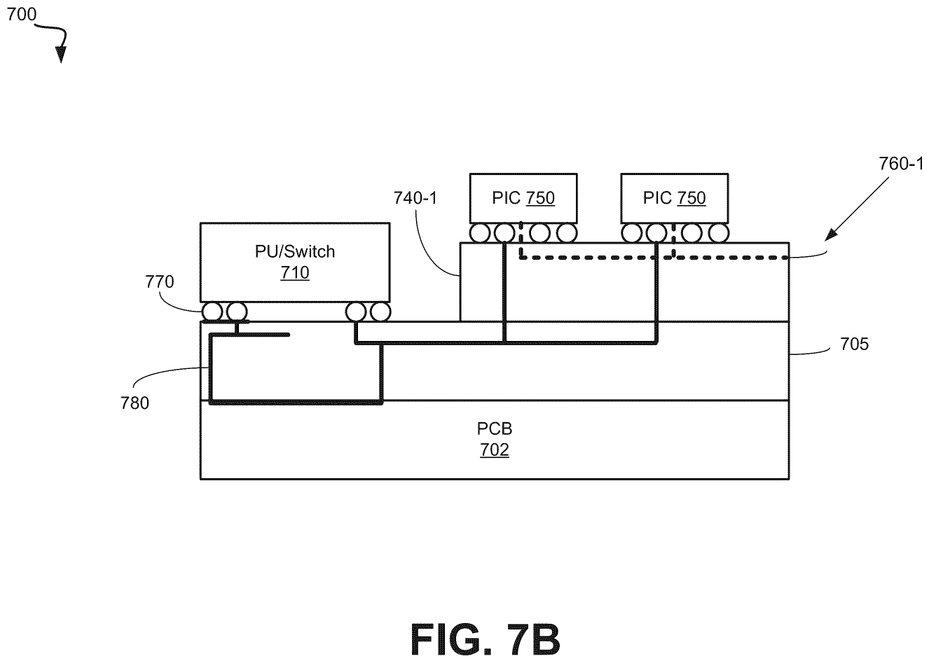

FIGS. 7A-7B are block diagrams of views of an apparatus or system 700, according to some embodiments. More specifically, FIG. 7A is a top-down view of the system 700, and FIG. 7B is a side view of the system 700.

As shown in FIG. 7A, system 700 can include printed circuit board (PCB) 702, base interconnect 705 (e.g., interposer), at least one processing unit and/or switch (PU/switch) 710 disposed on base interconnect 705, at least one network interface card (NIC) 720-1, 720-2 disposed on base interconnect 705, serializer-deserializer (SERDES) 730 disposed on base interconnect 705, multiple supplemental interconnects 740-1 through 740-3 disposed on base interconnect 705, multiple photonic integrated circuits (PICs) 750 disposed on each of supplemental interconnects 740-1 through 740-3, and multiple waveguides 760-1 through 760-3 each coupled to a respective one of supplemental interconnects 740-1 through 740-3. In some embodiments, and as shown, the number of supplemental interconnects is three. However, the number of supplemental interconnects should not be considered limiting. In some embodiments, and as shown, PICs 750 includes four PICs. However, the number of PICs should not be considered limiting.

More specifically, each of supplemental interconnects 740-1 through 740-3 can be disposed between respective PICs 750 and base interconnect 705. For example, as further shown in FIG. 7B, bumps 770 are disposed between PU/switch 710 and base interconnect 705, and between PICs 750 and supplemental interconnects 740-1 through 740-3. Signal connectors 780 can be formed through the base interconnect 705 and the supplemental interconnects 740-1 through 740-3 to enable electrical connections between components of the system 700 (e.g., PU/switch 710 and PICs 750). In some embodiments, the signal connectors can be or include conductive wires. Additionally, through each of supplemental interconnects 740-1 through 740-3, the signal connectors 780 can be or include a respective waveguide system can be formed to provide optical signals to the PICs 750.

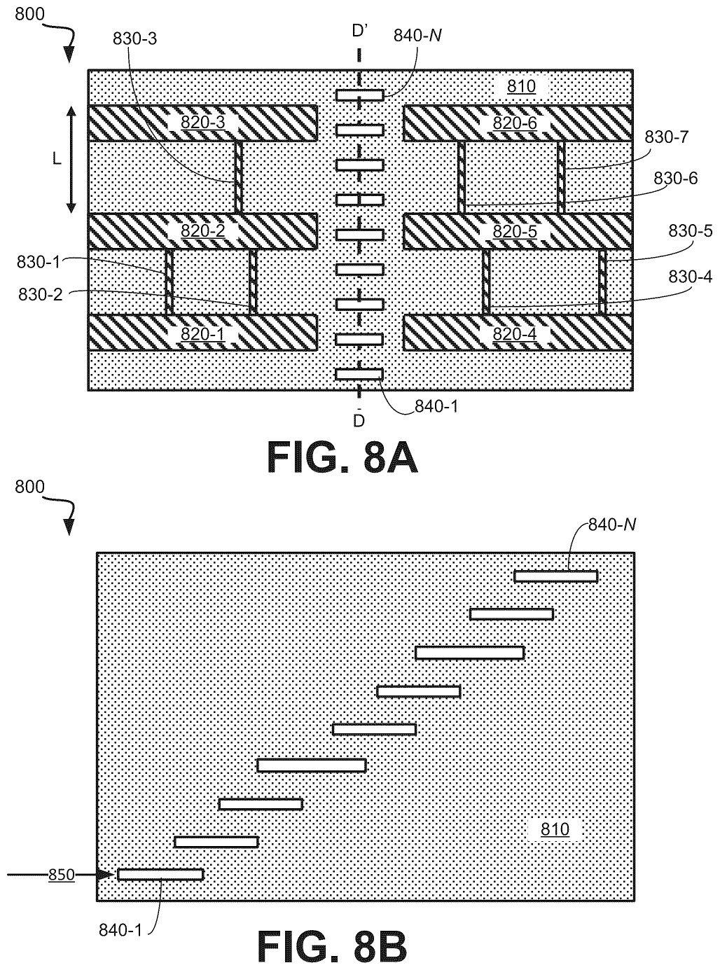

FIGS. 8A-8B are diagrams of views of a device 800 that can enable long-range evanescent wave coupling between photonic waveguides, according to some embodiments. More specifically, FIG. 8A is a cross-sectional view of device 800, and FIG. 8B is a side view of device 800 with respect to line D-D′. In some embodiments, device 800 is an interconnect. For example, device 800 can be supplemental interconnect 740-1 of FIGS. 7A-7B.

As shown, device 800 can include at least one material (“material”) 810, conductive layers 820-1 through 820-6, vias 830-1 through 830-7, and multiple inner cores 840 including inner core 840-1 through inner core 840-N. Inner cores 840-1 through 840-N can include any suitable material. In some embodiments, inner cores 840-1 through 840-N include silicon nitride.

Pairs of conductive layers can be connected by at least one via. For example, as shown in FIG. 8A, conductive layer 820-1 is connected to conductive layer 820-2 by vias 830-1 and 830-2. Conductive layer 820-2 is connected to conductive layer 820-3 by via 830-3. Conductive layer 820-4 is connected to conductive layer 820-5 by vias 830-4 and 830-5. Conductive layer 820-5 is connected to conductive layer 820-6 by vias 830-6 and 830-7. Pairs of conductive layers can be separated by a distance. For example, as shown in FIG. 8A, conductive layer 820-2 can be separated by conductive layer 820-3 by a distance L. In some embodiments, the distance L is greater than or equal to about 10 μm.

Material 810 insulates conductive layers 820-1 through 820-6 and vias 830-1 through 830-7. Simultaneously, material 810 forms a respective outer cladding layer on each of inner cores 840-1 through 840-N to enable optical coupling with sufficiently low absorption and/or propagation loss. Thus, each of inner cores 840-1 through 840-N corresponds to a respective waveguide including the inner core encapsulated by the cladding layer. Material 810 can include any suitable material that can insulate the conductive material and enable optical coupling with respect to inner cores 840-1 through 840-N, in accordance with some embodiments described herein. In some embodiments, material 810 is a dielectric material. For example, material 810 can include silicon dioxide. Accordingly, in some embodiments, material 810 includes at least one dielectric material forming ILD layers between conductive material.

As shown in FIG. 8B, material 810 and inner cores 840-1 through 840-N form a cascaded waveguide structure. In some embodiments, the cascaded waveguide structure includes a staircase pattern. More specifically, multiple waveguides can be arranged in a staircase pattern from an initial waveguide including initial inner core 840-1 to a final waveguide including final inner core 840-N. Such a cascaded waveguide structure can enable evanescent wave coupling between respective pairs of waveguides of the cascaded waveguide structure. For example, an optical signal (e.g. light) 850 can be received by the initial waveguide including inner core 840-1, and can be transferred through the cascaded waveguide structure toward the final waveguide structure including inner core 840-N.

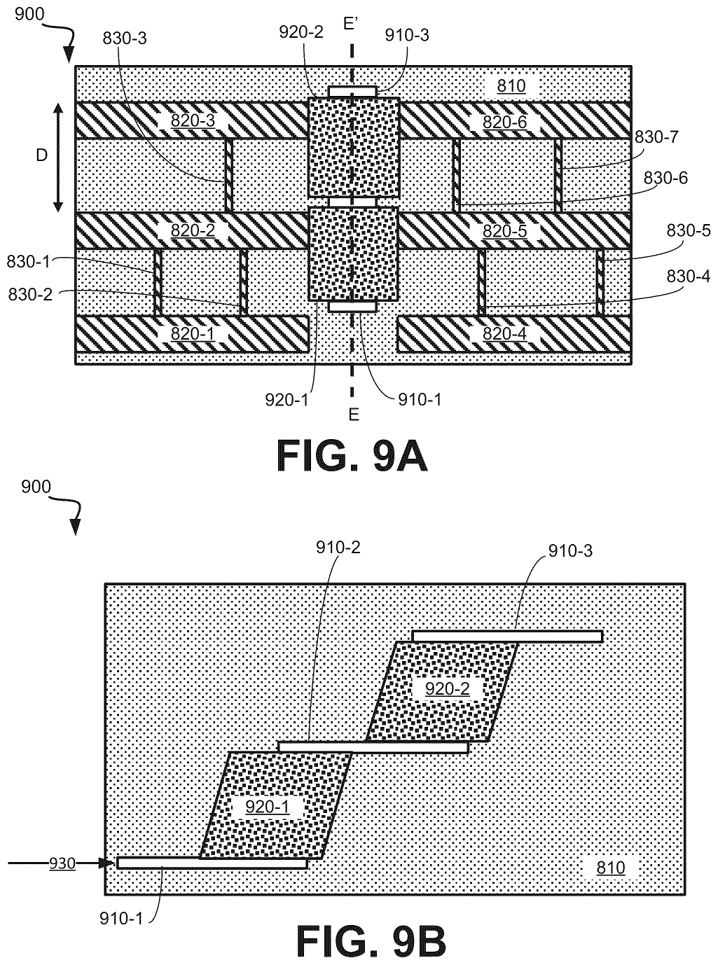

FIGS. 9A-9B are diagrams of views of a device that can enable long-range evanescent wave coupling between photonic waveguides, according to some embodiments. More specifically, FIG. 9A is a cross-sectional view of device 900, and FIG. 9B is a side view of device 900 through with respect to line E-E′. In some embodiments, device 900 is an interconnect. For example, device 900 can be supplemental interconnect 740-1 of FIGS. 7A-7B.

Similar to device 800 of FIGS. 8A-8B, device 900 can include material 810, conductive layers 820-1 through 820-6, and vias 830-1 through 830-7. As further shown, device 900 can further include inner cores 910-1 through 910-3. Inner cores 910-1 through 910-3 are similar to inner cores 810-1 through 810-N of FIGS. 7A-7B. Additionally, device 900 can include supplemental cladding structures (“cladding structures”) 920-1 and 920-2. More specifically, cladding structure 920-1 is disposed between inner core 910-1 and inner core 910-2, and cladding structure 920-2 is disposed between inner core 910-2 and inner core 910-3.

Cladding structures 920-1 and 920-2 can be formed from a cladding material (e.g., a dielectric material) having a higher index of refraction than material 810 used to form the ILD layer encapsulated the conductive material of device 900 (e.g., a material having a higher index of refraction than silicon dioxide). Each of cladding structures 920-1 and 920-2 can reduce coupling loss between the pair of waveguides because of the higher index of refraction. In some embodiments, and as shown in FIG. 9B, each of cladding structures 920-1 and 920-2 has a tapered geometry to reduce reflection loss at the respective boundaries between the cladding structure and the inner cores. For example, each of cladding structures 920-1 and 920-2 can have a parallelogram shape (e.g., rhombus shape) as viewed from the side.

Such a waveguide structure can enable evanescent wave coupling between respective pairs of waveguides of the waveguide structure. For example, an optical signal (e.g. light) 930 can be received by the initial waveguide including inner core 910-1, and can be transferred through the waveguide structure toward the final waveguide structure including inner core 910-3.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

As used herein, the singular forms “a,” “an,” and “the” include plural references unless the context clearly indicates otherwise. Thus, for example, reference to “a precursor” includes a single precursor as well as a mixture of two or more precursors; and reference to a “reactant” includes a single reactant as well as a mixture of two or more reactants, and the like.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%, such that “about 10” would include from 9 to 11.

The term “at least about” in connection with a measured quantity refers to the normal variations in the measured quantity, as expected by one of ordinary skill in the art in making the measurement and exercising a level of care commensurate with the objective of measurement and precisions of the measuring equipment and any quantities higher than that. In certain embodiments, the term “at least about” includes the recited number minus 10% and any quantity that is higher such that “at least about 10” would include 9 and anything greater than 9. This term can also be expressed as “about 10 or more.” Similarly, the term “less than about” typically includes the recited number plus 10% and any quantity that is lower such that “less than about 10” would include 11 and anything less than 11. This term can also be expressed as “about 10 or less.”

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A device comprising:
a plurality of conductive layers;
a plurality of inner cores disposed in a region between a first set of conductive layers of the plurality of conductive layers and a second set of conductive layers of the plurality of conductive layers, each inner core of the plurality of inner cores corresponding to a respective waveguide of a plurality of waveguides, wherein the plurality of inner cores is arranged in a cascaded waveguide structure; and
dielectric material simultaneously forming an interlevel dielectric for the plurality of conductive layers and at least a portion of a cladding layer for each waveguide of the plurality of waveguides.

2. The device of claim 1, wherein the cascaded waveguide structure comprises a staircase pattern.

3. The device of claim 1, wherein the dielectric material comprises silicon dioxide.

4. The device of claim 1, wherein each inner core of the plurality of inner cores comprises silicon nitride.

5. The device of claim 1, wherein the plurality of conductive layers comprises a first conductive layer and a second conductive layer having upper surfaces that are separated by a distance greater than or equal to about 10 micrometers.

6. The device of claim 1, wherein the plurality of conductive layers comprises a first conductive layer and a second conductive layer that are connected to each other by at least one via.

7. A device comprising:
a plurality of conductive layers;
a plurality of inner cores disposed in a region between a first set of conductive layers of the plurality of conductive layers and a second set of conductive layers of the plurality of conductive layers, each inner core of the plurality of inner cores corresponding to a respective waveguide of a plurality of waveguides, wherein the plurality of inner cores is arranged in a cascaded waveguide structure;
at least a first dielectric material simultaneously forming an interlevel dielectric for the plurality of conductive layers and a first portion of a cladding layer for each waveguide of the plurality of waveguides, the first dielectric material having a first index of refraction; and
at least one cladding structure disposed between at least one pair of inner cores to form a second portion of the cladding layer for at least one pair of waveguides corresponding to the at least one pair of inner cores, the at least one cladding structure comprising a second dielectric material having a second index of refraction greater than the first index of refraction.

8. The device of claim 7, wherein the cascaded waveguide structure comprises a staircase pattern.

9. The device of claim 7, wherein the first dielectric material comprises silicon dioxide.

10. The device of claim 7, wherein each inner core of the plurality of inner cores comprises silicon nitride.

11. The device of claim 7, wherein the plurality of conductive layers comprises a first conductive layer and a second conductive layer having upper surfaces that are separated by a distance greater than or equal to about 10 micrometers.

12. The device of claim 7, wherein the plurality of conductive layers comprises a first conductive layer and a second conductive layer that are connected to each other by at least one via.

13. A system comprising:
a printed circuit board;
at least one interconnect disposed on the printed circuit board; and
a set of photonic integrated circuits disposed on the at least one interconnect;
wherein the at least one interconnect comprises:
a plurality of conductive layers;
a plurality of inner cores disposed in a region between a first set of conductive layers of the plurality of conductive layers and a second set of conductive layers of the plurality of conductive layers, each inner core of the plurality of inner cores corresponding to a respective waveguide of a plurality of waveguides, wherein the plurality of inner cores is arranged in a cascaded waveguide structure; and
at least one dielectric material simultaneously forming an interlevel dielectric for the plurality of conductive layers and at least a portion of a cladding layer for each waveguide of the plurality of waveguides.

14. The system of claim 13, wherein the cascaded waveguide structure comprises a staircase pattern.

15. The system of claim 13, wherein the at least one dielectric material comprises silicon dioxide.

16. The system of claim 13, wherein each inner core of the plurality of inner cores comprises silicon nitride.

17. The system of claim 13, wherein the plurality of conductive layers comprises a first conductive layer and a second conductive layer having upper surfaces that are separated by a distance greater than or equal to about 10 micrometers.

18. The system of claim 13, wherein the plurality of conductive layers comprises a first conductive layer and a second conductive layer that are connected to each other by at least one via.

19. The system of claim 13, wherein the at least one interconnect further comprises at least one cladding structure disposed between at least one pair of inner cores to form a second portion of the cladding layer for at least one pair of waveguides corresponding to the at least one pair of inner cores.

20. The system of claim 19, wherein the dielectric material has a first index of refraction, and wherein the at least one cladding structure comprises a second dielectric material having a second index of refraction greater than the first index of refraction.
